(19) United States
(12) Patent Application Publication
(10) Pub. No.: US 2026/0252023 A1
(43) Pub. Date: Aug. 27, 2026

(54) POST-PROCESSING APPARATUS AND IMAGE FORMING APPARATUS

(71) Applicant: Konica Minolta, Inc., Tokyo (JP)

(72) Inventor: Shohei OTSUBO, Tokyo (JP)

(21) Appl. No.: 19/551,676

(22) Filed: Feb. 27, 2026

(30) Foreign Application Priority Data
Feb. 27, 2025 (JP) 2025-030427

(51) Int. Cl. G03G 15/00; B65H 45/30

(52) U.S. Cl. CPC G03G 15/6582; B65H 45/30; B65H 2801/27; G03G 2215/00704

(57) ABSTRACT

An image forming apparatus includes: a crease forming module that forms a crease in a sheet; a slot section that receives the crease forming module, in which the crease forming module includes: a first crease processor that includes a first protruding portion facing a first surface of the sheet and a first recessed portion facing a second surface of the sheet, and forms a first crease in the sheet by engagement between the first protruding portion and the first recessed portion, and a second crease processor that includes a second recessed portion facing the first surface of the sheet and a second protruding portion facing the second surface of the sheet, and forms a second crease in the sheet by engagement between the second recessed portion and the second protruding portion.

### CROSS REFERENCE TO RELATED APPLICATIONS

The entire disclosure of Japanese Patent Application No. 2025-030427 filed on February 27, 2025 is incorporated herein by reference in its entirety.

### BACKGROUND

### Technological Field

The present invention relates to a post-processing device and an image forming apparatus.

### Description of Related Art

As an apparatus for processing a sheet, Japanese Unexamined Patent Publication No. 2015-48185 is known as an apparatus in which processing mechanisms capable of performing processing such as cutting, perforation, and creasing (fold line) on a sheet are each modularized, and these modules can be replaced with each other according to the use (see, for example, Patent Literature (hereinafter, referred to as “PTL” 1).

In this apparatus, an apparatus main body is provided with a plurality of slots (unit receiving portions) arranged along a sheet conveyance path, and modules of the respective processing mechanisms are combined and attached to the slots to manufacture printed materials corresponding to various applications.

As the modules, a module to cut the sheet, a perforation forming module to form a perforation in the sheet, a crease forming module to form a crease in the sheet and the like are known. In particular, as the crease forming module, there are a module for forming a crease in a conveyance direction (longitudinal crease) with respect to the sheet and a module for forming a crease in a direction (lateral direction, latitudinal crease) orthogonal to the conveyance direction. Note that in a conveyance plane in which a sheet is conveyed, the conveyance direction is referred to as an FD direction and the direction orthogonal to the conveyance direction is referred to as a CD direction. The module for forming a crease in the CD direction includes a recessed portion and a protruding portion that are disposed opposite to each other with the conveyance path in between and forms a crease extending in the CD direction by pinching, pressing, and separating the sheet on the conveyance path between the recessed portion and the protruding portion.

Meanwhile, there are various demands for a crease formed by using the crease forming module. For example, when an elongated bellows-like printed material such as a small pamphlet is produced, first, a sheet is conveyed into the apparatus with the longitudinal direction of the sheet aligned with the conveyance direction. Next, it is efficient to manufacture the sheet by cutting the sheet in the conveyance direction and performing crease processing of forming mountain folds and valley folds in a direction orthogonal to the conveyance direction by the apparatus.

To manufacture an elongated bellows-like printed material or the like with a conventional apparatus, it is necessary to perform a plurality of processing operations such as cutting of a sheet in a conveyance direction and cutting of the sheet in a direction orthogonal to the conveyance direction in addition to crease processing of mountain folding and valley folding.

However, in the conventional apparatus, the module that performs crease processing of each of the mountain fold and the valley fold occupies two slots, and therefore, in a case where the number of sheets to be processed increases, another module cannot be attached, resulting in a problem that the degree of freedom in processing on sheets is low. On the other hand, a configuration in which the number of slots in which other modules are mounted is increased in the apparatus can be considered, but there is a problem in that the apparatus is increased in size and cannot be disposed in a space-saving manner.

### SUMMARY

Objectives of the present invention include providing a post-processing device and an image forming apparatus which are downsized and can increase the degree of freedom of processing including crease processing on a sheet.

In order to achieve at least one of the above-described objectives, a post-processing device reflecting one aspect of the present invention includes:

a crease forming module that forms a crease in a sheet;

a slot section that receives the crease forming module, wherein

the crease forming module includes:

a first crease processor that includes a first protruding portion facing a first surface of the sheet and a first recessed portion facing a second surface of the sheet, and forms a first crease in the sheet by engagement between the first protruding portion and the first recessed portion, and

a second crease processor that includes a second recessed portion facing the first surface of the sheet and a second protruding portion facing the second surface of the sheet, and forms a second crease in the sheet by engagement between the second recessed portion and the second protruding portion.

An image forming apparatus reflecting one aspect of the present invention includes:

an image forming main body that forms an image on a sheet, and a post-processing device having the above-described configuration.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image forming apparatus including a post-processing device according to Embodiment 1 of the present invention;

FIG. 2 is a diagram illustrating a main part of a control system of an image forming apparatus main body;

FIG. 3 is a conceptual diagram of a crease module which is a main configuration of the post-processing device;

FIG. 4 is a schematic diagram of the crease module illustrating a configuration of main parts of the post-processing device;

FIGS. 5A and 5B are side views schematically illustrating operation of a first crease processing section of the crease module illustrated in FIG. 4;

FIGS. 6A and 6B are side views schematically illustrating operation of a second crease processing section of the crease module illustrated in FIG. 4;

FIGS. 7A and 7B are views schematically showing an example of a modification example of the second crease processing section of the crease module;

FIG. 8A is a diagram schematically illustrating an example of a combination of modules in a post-processing device;

FIG. 8B is a diagram illustrating an example of a processed material output by the post-processing device illustrated in FIG. 8A;

FIG. 9A is a schematic diagram illustrating an example of a post-processing device including a crease processing section according to the related art;

FIG. 9B is a diagram illustrating an example of a processed material output by the post-processing device illustrated in FIG. 9A;

FIG. 10A is a schematic diagram of a crease module illustrating a configuration of relevant parts of a post-processing device according to Embodiment 2 of the present invention;

FIG. 10B is a diagram schematically showing a positional relationship of the crease processing section in FIG. 10A;

FIG. 11A is a schematic diagram of the crease module after the first crease processing section is moved in FIG. 10A;

FIG. 11B is a diagram schematically showing a positional relationship of the crease processing section in FIG. 11A;

FIG. 12 is a schematic view showing a modification example of the arrangement of the first crease processing section and the second crease processing section in the crease module, which shows the main configuration of the post-processing device according to Embodiment 2 of the present invention;

FIG. 13 is a diagram illustrating another modification example of the arrangement of the first crease processing section and the second crease processing section;

FIGS. 14A and 14B are diagrams showing other modification examples of the arrangement of the first crease processing section and the second crease processing section; and

FIG. 15 is a view showing another modification example of the arrangement of the first crease processing section and the second crease processing section.

### DETAILED DESCRIPTION OF EMBODIMENTS

Hereinafter, one or more embodiments of the present invention will be described with reference to the drawings. However, the scope of the invention is not limited to the disclosed embodiments.

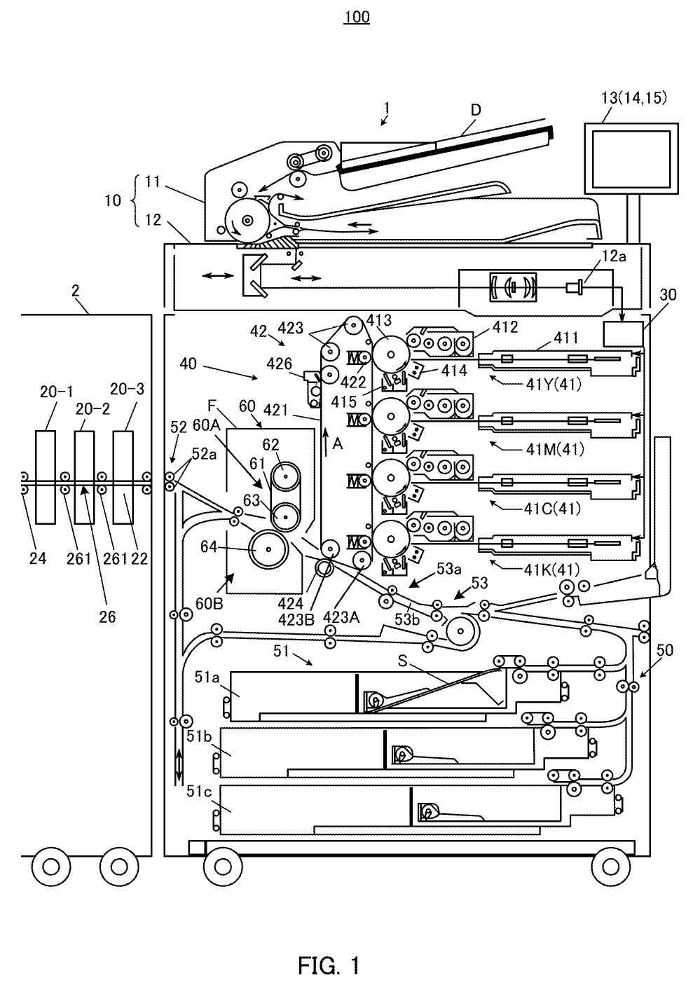

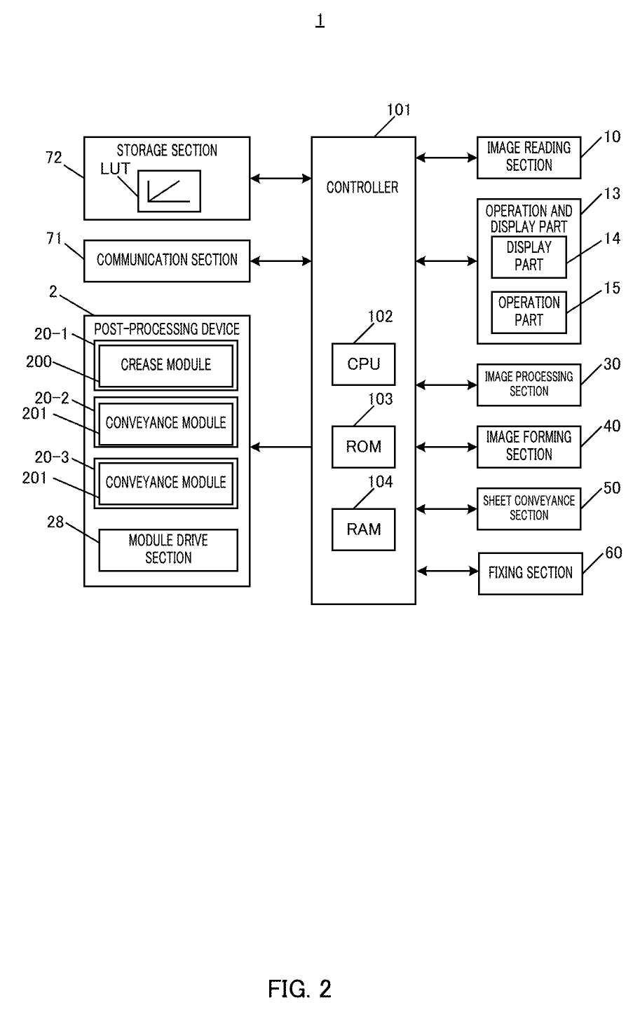

Hereinafter, an embodiment of the present invention will be described in detail with reference to the drawings. FIG. 1 is a diagram schematically showing an overall configuration of an image forming apparatus 100 including a post-processing device 2 having a crease module 200 according to an embodiment of the present invention. FIG. 2 is a diagram illustrating a main part of a control system of the image forming apparatus main body 1 in the image forming apparatus 100.

As illustrated in FIG. 1, the image forming apparatus 100 is formed by connecting an image forming apparatus main body 1 and a post-processing device 2 from the upstream along a conveyance direction of a sheet S as an example of a sheet material.

### Image Forming Apparatus Main Body 1

The Image forming apparatus main part 1 is a color image forming apparatus of an intermediate transfer system using electrophotographic process technology. That is, the image forming apparatus main body 1 primarily transfers toner images of respective colors of Y (yellow), M (magenta), C (cyan), and K (black) formed on the photosensitive drums 413 to the intermediate transfer belt 421 and superimposes the toner images of four colors on the intermediate transfer belt 421. Thereafter, the image forming apparatus main body 1 forms an image by performing secondary transfer onto the sheet S sent out from the sheet feed tray units 51a to 51c.

The image forming apparatus main body 1 adopts a tandem system whereby photosensitive drums 413 corresponding to the four colors of Y, M, C, and K are arranged in series in a travel direction of the intermediate transfer belt 421, and the toner images of the respective colors are sequentially transferred onto the intermediate transfer belt 421 by a single procedure.

As shown in FIG. 2, the image forming apparatus main body 1 includes an image reading section 10, an operation and display part 13, an image processing section 30, an image forming section 40, a sheet conveyance section 50, a fixing section 60, and a controller 101.

The controller 101 includes a central processing section (CPU) 102, a read only memory (ROM) 103, a random access memory (RAM) 104, and the like. The CPU 102 reads a program according to processing contents from the ROM 103, loads the program in the RAM 104, and integrally controls an operation of each block and the like of the image forming apparatus 1 in cooperation with loaded program. At this time, various kinds of data stored in the storage section 72 are referred to. The storage section 72 is constituted by, for example, a nonvolatile semiconductor memory (so-called flash memory) or a hard disk drive.

The controller 101 receives a sheet processing condition from the operation part 15 of the operation and display part 13 and displays operation information of the post-processing device 2 on the display part 14.

The controller 101 reads user-owned information, which is the processing type of each processing module in the post-processing device 2, from the storage section 72, and appropriately drives the processing modules (200 and 201 to 203) via the module drive section 28.

The controller 101 transmits/receives various types of data to/from an external device (e.g., a personal computer) connected to a communication network such as a local area network (LAN), a wide area network (WAN) via a communication section 71. For example, the controller 101 receives image data (input image data) transmitted from an external device and controls to form an image on the sheet S on the basis of the image data. The communication section 71 is constituted by a communication control card such as a LAN card.

As shown in FIG. 1, the image reading section 10 includes an automatic document feeding device 11 called an Auto Document Feeder (ADF), a document image scanning device 12 (scanner), and the like.

The automatic document feeder 11 conveys a document D placed on a document tray by a conveyance mechanism and sends the document D to the document image scanner 12. Using the automatic document feeder 11, it is possible to continuously and collectively read images of a large number of documents D placed on the document tray (including both faces).

The document image scanning device 12 optically scans a document conveyed from the automatic document feeding device 11 onto a contact glass or a document placed on the contact glass, and forms an image of light reflected from the document on a light receiving surface of a charge-coupled device (CCD) sensor 12a. Thus, the document image scanning device 12 reads a document image. The image reading section 10 generates input image data based on a result of reading by the document image scanning device 12. The input image data undergoes predetermined image processing in the image processing section 30.

As illustrated in FIG. 2, the operation and display part 13 includes, for example, a liquid crystal display (LCD) with a touch screen, and functions as the display part 14 and the operation part 15. According to a display control signal input from the controller 101, the display part 14 displays various operation screens, states of images, individual function operation status, or the like. The operation part 15 includes various operation keys such as a numeric keypad, and a start key, receives various input operation from a user, and outputs an operation signal to the controller 101.

The image processing section 30 includes a circuit and the like that applies digital image processing in accordance with initial settings or user settings. For example, the image processing section 30 performs tone correction on the basis of tone correction data (tone correction table) under the control of the controller 101. The image processing section 30 applies to the input image data, not only the tone correction but also various kinds of correction processing such as color correction and shading correction, compression processing, and the like. The image forming section 40 is controlled on the basis of the processed image data.

As illustrated in FIG. 1, the image forming section 40 forms an image on a sheet S based on the settings of a print job. The image forming section 40 includes image forming units 41Y, 41M, 41C, 41K, and an intermediate transfer unit 42 for forming images with color toners of Y, M, C, and K components.

The image forming units 41Y, 41M, 41C, and 41K for the Y component, the M component, the C component, and the K component have a similar configuration. For convenience of illustration and description, common components are denoted by the same reference numerals, and when the components are distinguished from each other, Y, M, C, or K is added to the reference numerals. In FIG. 1, reference signs are representatively provided to the constituent elements of the image forming unit 41Y for the Y constituent elements and the reference signs of the constituent elements of the other image forming units 41M, 41C, 41K are omitted.

The image forming unit 41 includes an exposure device 411, a developing device 412, a photosensitive drum 413, a charging device 414, and a drum cleaning device 415.

The photosensitive drum 413 is formed of, for example, an organic photoreceptor in which a photosensitive layer formed of resin containing an organic photoconductor is formed on an outer circumferential surface of a drum-shaped metal substrate.

The controller 101 controls a drive current supplied to a driving motor (not illustrated) that rotates the photosensitive drum 413 so as to rotate the photosensitive drum 413 at a constant peripheral speed.

The charging device 414 is, for example, an electrostatic charger, and uniformly charges the surface of the photosensitive drum 413 having photoconductivity to a negative polarity by generating corona discharge.

Exposure device 411 is formed of, for example, a semiconductor laser, and irradiates photoconductive drum 413 with laser light corresponding to an image of each color component. As a result, on the image area of the surface of the photosensitive drum 413 irradiated with the laser light, an electrostatic latent image of each color component is formed due to a potential difference from the background area.

The developing device 412 is a developing device of a two component reverse rotation method and forms a toner image by visualizing the electrostatic latent image by causing developer of each of the color components to adhere to the surface of the photosensitive drum 413.

A developing bias applied to the developing device 412 is, for example, either a DC developing bias having the same polarity as a charging polarity of the charging device 414, or a developing bias obtained by superposing a DC voltage having the same polarity as the charging polarity of the charging device 414 on an AC voltage. As a result, inversion development, in which the toner is made to adhere to the electrostatic latent image formed by the exposure device 411, is performed.

The drum cleaning device 415 is made to abut on the surface of the photosensitive drum 413, includes a plate-like drum cleaning blade or the like including an elastic body, and removes the toner not transferred to the intermediate transfer belt 421 and remaining on the surface of the photosensitive drum 413.

The intermediate transfer unit 42 includes an intermediate transfer belt 421, a primary transfer roller 422, a plurality of support rollers 423, a secondary transfer roller 424, and a belt cleaning device 426.

The intermediate transfer belt 421 is formed of an endless belt and wound under tension in a loop between the plurality of support rollers 423. At least one of the plurality of support rollers 423 is constituted by a driving roller, and the other support rollers are constituted by driven rollers. For example, preferably, a roller 423A arranged more on a downstream in a belt travel direction than a primary transfer roller 422 for the K component is a drive roller. Thus, the traveling speed of the belt at a primary transfer section is easily kept constant. The rotation of the drive roller 423A causes the intermediate transfer belt 421 to travel in a direction of the arrow A at a constant speed.

The intermediate transfer belt 421 is a belt having conductivity and elasticity and includes a high resistance layer on a surface thereof. The intermediate transfer belt 421 is rotationally driven by a control signal from the controller 101.

The primary transfer roller 422 is arranged on an inner peripheral surface side of the intermediate transfer belt 421 in a manner facing the photosensitive drum 413 of each color component. The primary transfer roller 422 is brought into pressure contact with the photosensitive drum 413 with the intermediate transfer belt 421 interposed therebetween, thereby forming a primary transfer nip for transferring a toner image from the photosensitive drum 413 to the intermediate transfer belt 421.

The secondary transfer roller 424 is disposed on the outer peripheral surface side of the intermediate transfer belt 421 so as to face the backup roller 423A disposed on the downstream side of the driving roller 423B in the belt traveling direction. The secondary transfer roller 424 is pressed against and brought into contact with the backup roller 423B portion with the intermediate transfer belt 421 interposed therebetween, thereby forming a secondary transfer nip for transferring the toner image from the intermediate transfer belt 421 to the sheet S.

When the intermediate transfer belt 421 passes through each of the primary transfer nips, the toner image on each of the respective photosensitive drums 413 is sequentially superimposed and primarily transferred onto the intermediate transfer belt 421. Specifically, the toner images are electrostatically transferred to the intermediate transfer belt 421 by applying primary transfer bias to the primary transfer roller 422 and applying electric charge having an opposite polarity of the toner to a back-surface side of the intermediate transfer belt 421, that is to say, a side on which the primary transfer roller 422 abuts.

Thereafter, when the sheet S passes through the secondary transfer nip, the toner images on the intermediate transfer belt 421 are secondarily transferred to the sheet S. Specifically, the toner images are electrostatically transferred to the sheet S by applying secondary transfer bias to the secondary transfer roller 424 and applying electric charge having an opposite polarity of the toner to a back-surface side of the sheet S, that is to say, a side on which the secondary transfer roller 424 abuts. The sheet S on which the toner image has been transferred is conveyed toward the fixing section 60.

The belt cleaning device 426 removes transfer residual toner remaining on the surface of the intermediate transfer belt 421 after the secondary transfer.

The fixing section 60 includes an upper fixing section 60A having a fixing surface side member to be arranged on the fixing surface side of the sheet S, that is, the side on which the toner image is formed, a lower fixing section 60B having a back surface side supporting member to be arranged on the back surface side of the sheet S, that is, the side opposite to the fixing surface side, and a heating source. The back-surface-side support member is brought into pressure contact with the fixing-surface-side member, so that a fixing nip that nips and conveys sheet S is formed.

The fixing section 60 heats and pressurizes the conveyed sheet S, on which the toner images have been secondarily transferred, at the fixing nip, thereby fixing the toner images on the sheet S. The fixing section 60 is disposed as a unit in a fixing device F.

The upper fixing section 60A includes an endless fixing belt 61, a heating roller 62, and a fixing roller 63, which are fixing-surface-side members. The fixing belt 61 is wound under tension between the heating roller 62 and the fixing roller 63.

The lower fixing section 60B includes a pressure roller 64 that is a back surface side support member. The pressure roller 64 and the fixing belt 61 define a fixing nip for holding and conveying a sheet S therebetween.

The sheet conveyance section 50 includes a sheet feed section 51, a sheet ejection section 52, and a conveyance path section 53. In the three sheet feed tray units 51a to 51c constituting the sheet feed section 51, sheets S (standard sheets, special sheets) identified based on the basis weight, size, and the like are accommodated for each type set in advance.

The conveyance path section 53 includes a plurality of conveyance roller pairs such as a registration roller pair 53a, and a normal conveyance path 53b along which the sheet S is passed through the image forming section 40 and the fixing section 60 and ejected to the outside of the image forming apparatus 1.

The sheets S contained in the sheet feed tray units 51a to 51c are fed one by one from the top and are conveyed to the image forming section 40 by the conveyance path section 53. In the image forming section 40, the toner images on the intermediate transfer belt 421 are collectively secondarily transferred to one surface side of the sheet S, and fixing processing is applied in the fixing section 60. The sheet S carrying a formed image is ejected to the outside of the apparatus by the sheet ejection section 52 having a sheet ejection roller 52a and is supplied to the post-processing device 2.

### Post-Processing Device 2

The post-processing device 2 performs processing of different processing types, for example, cutting, creasing (fold crease) and the like on the sheet S ejected from the image forming apparatus main body 1.

The post-processing device 2 includes processing modules (200 and 201 to 203) for performing processing of different processing types, a sheet feed roller 22, a sheet ejection roller 24, a conveyance path 26, and slots 20 (20-1 to 20-3) for receiving the processing modules.

The post-processing device 2 further includes a module drive section 28 (refer to FIG. 2) that drives each of the processing modules (200 and 201 to 203) received in the slots 20.

The module drive section 28 controls the driving of the processing modules received in the respective slots 20-1 to 20-3 by control signals from the controller 101 on the basis of information input via the controller 101.

The module drive section 28 includes a drive source which is driven and controlled by the controller 101 provided in the image forming apparatus main body 1, and the drive source is connected to the processing modules received in the respective slots 20-1 to 20-3 to drive the respective processing modules. Note that the controller for driving and controlling the module drive section 28 may be provided in the post-processing device. Thus, processing including crease processing can be appropriately performed on the sheet to be conveyed into the post-processing device 2 without requiring the image forming apparatus main body 1.

The sheet feed roller 22 is provided as a sheet feed section in the image forming apparatus main body 1. The sheet ejection roller 24 is provided as a sheet ejection section.

The conveyance path 26 conveys a sheet from the sheet feed roller 22 to the sheet ejection roller 24, and is formed by a plurality of conveyance rollers 261. On the conveyance path 26, a plurality of slots 20 (20-1 to 20-3) are disposed side by side in the conveyance direction.

The slot 20 is formed in the apparatus main body so as to removably receive each of the processing modules, and the processing module received in the slot 20 is configured to appropriately perform predetermined processing on the sheet conveyed in the conveyance path 26.

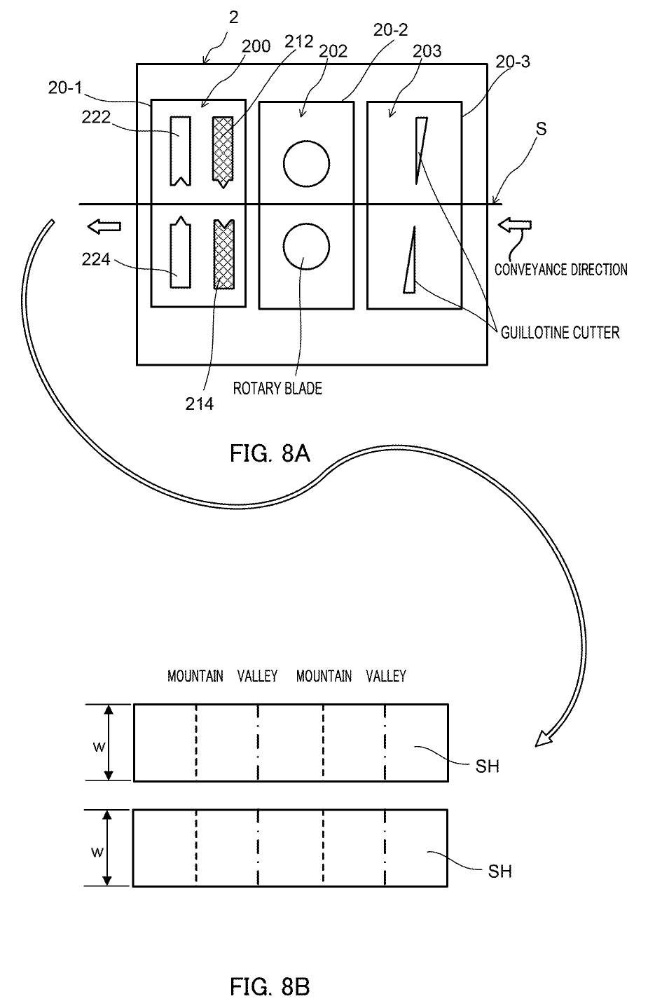

The processing modules included in the post-processing device include, for example, the crease module 200, the conveyance module 201, the FD cutting module 202 (refer to FIG. 8A), the CD cutting module 203 (refer to FIG. 8A), and the like.

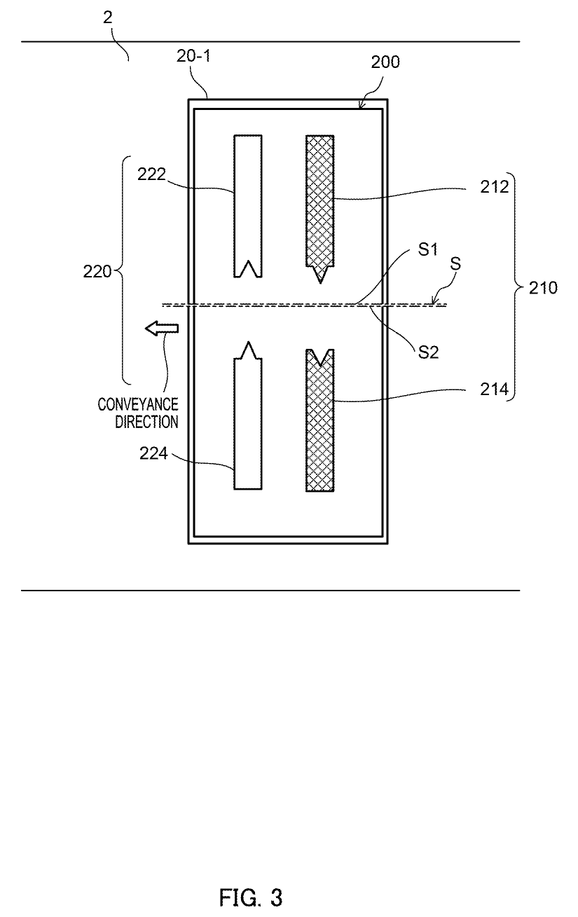

The post-processing device 2 includes, as the processing module, in particular, the crease module 200 for forming a crease on the sheet. FIG. 3 is a conceptual diagram of a crease module which is a main component of the post-processing device.

The crease module 200 shown in FIG. 3 is received in any one (for example, the slot 20-1) of the plurality of slots 20 of the post-processing device 2.

The crease module 200 includes a first crease processing section 210 that forms a crease (valley fold) as a first crease and a second crease processing section 220 that forms a crease (mountain fold) as a second crease in a direction (CD direction) orthogonal to the conveyance direction with respect to the sheet S.

The first crease processing section 210 and the second crease processing section 220 are disposed away from each other in the conveyance direction. The first crease processing section 210 and the second crease processing section 220 may be provided adjacent to each other or side by side in the same direction as the conveyance direction of the sheet.

The first crease processing section 210 includes a first protruding portion 212 that faces the first surface S1 of the sheet S and a first recessed portion 214 that faces the second surface S2 of the sheet S.

The first protruding portion 212 and the first recessed portion 214 are disposed to face each other with the sheet S interposed therebetween. The first protruding portion 212 and the first recessed portion 214 approach each other, sandwich the sheet S, and move to a position where they are fitted to each other, so that a crease (valley fold) extending in the CD direction, that is, a direction orthogonal to the conveyance direction is formed on the sheet S.

On the other hand, the second crease processing section 220 has a second recessed portion 222 facing the first surface S1 of the sheet S and a second protruding portion 224 facing the second surface S2 of the sheet S.

The second recessed portion 222 and the second protruding portion 224 are arranged to face each other with the sheet S interposed therebetween. The second recessed portion 222 and the second protruding portion 224 move to positions where they come close to each other, sandwich the sheet S, and are fitted to each other, and thus a crease (mountain fold) extending in the CD direction is formed on the sheet S.

As described above, the crease module 200 includes the first crease processing section 210 and the second crease processing section 220 in one module which is received in one slot.

The first crease processing section 210 includes a first protruding portion 212 that faces the first surface S1 of the sheet S and a first recessed portion 214 that faces the second surface S2 of the sheet S. The first protruding portion 212 and the first recessed portion 214 are engaged with each other to form a first crease (for example, a valley fold) in the sheet S.

The second crease processing section 220 includes a second recessed portion 222 facing the first surface S1 of the sheet S and a second protruding portion 224 facing the second surface of the sheet S. The second recessed portion 222 and the second protruding portion 224 are engaged with each other to form a second crease (for example, mountain fold) in the sheet S.

The conveyance module 201 conveys the sheet to the next slot 20 without processing the sheet. The conveyance module 201 is constituted by conveyance rollers for conveying the sheet S in the conveyance direction, for example, in the slots 20.

The first creasing processor 210 and the second creasing processor 220 may have the same configuration, and the first protruding portion 212 facing the second surface S2 may correspond to the second protruding portion 224 and the first recessed portion 214 facing the first surface may correspond to the second recessed portion 222. A structure for driving the first crease processing section 210 and the second crease processing section 220 in the crease module 200 will be described later.

As other processing modules, the FD cutting module 202 has a function of cutting the sheet in the FD direction, and the CD cutting module 203 has a function of cutting the sheet in the CD direction. The FD cutting module 202 includes a rotary blade that rotates along the conveyance direction, and the CD cutting module 203 includes, for example, a guillotine blade that extends in the lateral direction and is arranged so as to be able to approach and separate from the sheet.

Furthermore, the processing module may further include a perforation forming module that forms a perforation in the sheet conveyance direction or in a direction orthogonal to the sheet conveyance direction, and a half cut forming module that forms a half cut in the sheet conveyance direction or in a direction orthogonal to the sheet conveyance direction.

When the processing modules are received in the respective slots 20, the processing modules can be driven and controlled by the drive controller to perform respective different types of processing on a sheet conveyed in the conveyance path.

Note that although the number of a plurality of slots 20 (20-1 to 20-3) provided is three in the post-processing device 2, there is no limitation to this and it is sufficient that there be two or more, and one of the slots 20 receives the crease module 200.

The post-processing device 2 can form mountain-shaped and valley-shaped creases (folding lines) in lateral direction on a sheet with one slot 20-1 in which the crease module 200 is mounted.

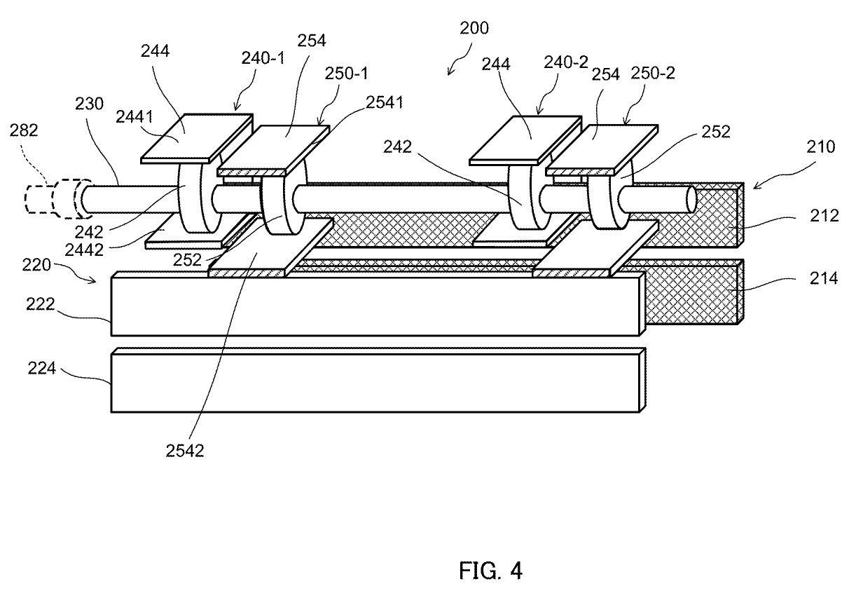

FIG. 4 is a schematic diagram of a crease module showing a configuration of a main part of the post-processing device.

The crease module 200 is a module that is attached to the slot 20 and drives the first crease processing section 210 and the second crease processing section 220 to form one or both of a mountain fold and a valley fold in a sheet to be conveyed.

The crease module 200 moves one of the first protruding portion 212 and the first recessed portion 214 in the first crease processing section 210 to the other so as to be engaged and disengaged, and moves one of the second recessed portion 222 and the second protruding portion 224 in the second crease processing section 220 to the other so as to be engaged and disengaged.

The crease module 200 includes a first crease processing section 210, a second crease processing section 220, a transmission shaft unit 230, first drive sections 240, and second drive sections 250.

In the first crease processing section 210, the first protruding portion 212 is disposed to face the first surface of the sheet (above the conveyance surface of the sheet) and the first recessed portion 214 is disposed to face the second surface of the sheet (below the conveyance surface of the sheet). The first protruding portion 212 and the first recessed portion 214 are arranged to face each other in the vertical direction with respect to the sheet conveyance surface.

In the second crease processing section 220, the second recessed portion 222 is disposed to face the first surface of the sheet, and the second protruding portion 224 is disposed to face the second surface of the sheet. The second recessed portion 222 and the second protruding portion 224 are disposed opposite to each other in a vertical direction with respect to the conveyance surface of the sheet.

One of the first protruding portion 212 and the first recessed portion 214 and one of the second recessed portion 222 and the second protruding portion 224 reciprocate in the vertical direction, and the respective recessed and protruding portions arranged to face each other in the moving direction can be engaged and disengaged.

The transmission shaft portion 230 transmits a driving force from the post-processing device 2 to the first crease processing section 210 and the second crease processing section 220 to drive the first crease processing section 210 and the second crease processing section 220.

The transmission shaft portion 230 is a rotatable drive member that is connected to the drive source of the module drive section 28 via the drive connection portion 282 when the crease module 200 is received in the slot 20. Note that also when another processing module which is drive-controlled to process a sheet is received in the slot 20, the drive connection portion 282 is connected to a drive member of the other processing module, so that each module can be appropriately selected to perform various processing on the sheet.

The transmission shaft portion 230 is disposed to be separated from the first crease processing section 210 and the second crease processing section 220 in a vertical direction with respect to a conveyance surface (corresponding to the sheet S).

The transmission shaft portion 230 is, for example, disposed above and between the first crease processing section 210 and the second crease processing section 220 with respect to the first crease processing section 210 and the second crease processing section 220. The first drive sections 240 and the second drive sections 250 are configured to be driven by the rotation of the transmission shaft portion 230.

The first drive sections 240 and the second drive sections 250 include a cam mechanism. Each of the first drive section 240 includes a cam portion 242 eccentrically attached to the transmission shaft portion 230, a link portion 244 that is displaced in an up-down direction by rotation of the cam portion 242, and a guide portion 248 that guides the up-down movement of the link portion 244.

The cam portion 242 is attached to the transmission shaft portion 230 via a clutch portion 234 capable of connecting and disconnecting the rotational force of the transmission shaft portion 230.

The link portion 244 includes upper and lower portions 2441 and 2442 that sandwich the cam portion 242 from above and below (in the reciprocating direction), and the first protruding portion 212 is provided at the lower portion so as to protrude downward. The link portion 244 is displaceable in a reciprocation direction (e.g., an up-down direction, or a direction perpendicular to the conveyance surface) along the guide portion 248 via the slide portion 246.

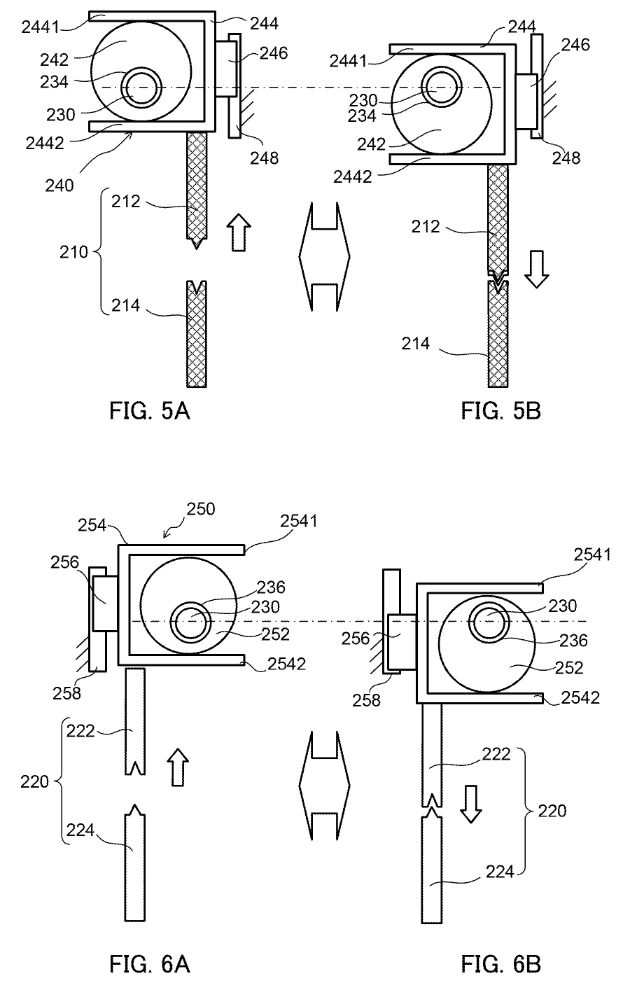

In the first drive section 240, the transmission shaft portion 230 rotates in the engaged state of the clutch 234, as illustrated in FIGS. 5A and 5B. Following the rotation of the transmission shaft portion 230, the cam portion 242 rotates, and the outer periphery of the cam portion 242 slides between the upper and lower portions 2441 and 2442 of the link portion 244 which is restricted by the guide portion 248 to move only in the vertical direction.

Rotation of the cam portion 242 causes the link portion 244 to move up and down (in the reciprocating direction). Along with the movement of the link portion 244, the first protruding portion 212 moves toward the first recessed portion 214, and the first recessed portion 214 and the recessed-protruding portion engage with each other. As a result, the first protruding portion 212 sandwiches the sheet and engages with and disengages from the first recessed portion 214 to form a first folding line (valley fold).

Each of the second drive sections 250 is configured in the same manner as the first drive section 240, and as shown in FIGS. 6A and 6B, has a cam portion 252 that is eccentrically attached to the transmission shaft portion 230 at a position that does not overlap with the cam portion 242 of the first drive section 240. Similarly to the cam portion 242, the cam portion 252 is attached to the transmission shaft portion 230 via the clutch 236.

The cam portion 252 is arranged between the upper and lower portions of the link portion 254, the link portion 254 moves up and down by the rotation of the cam portion 252, and the second recessed portion 222 provided at the lower portion of the link portion 254 moves to the side of the second protruding portion 224. As a result, the second recessed portion 222 sandwiches the sheet and engages with and disengages from the second protruding portion 224 to form a crease (mountain fold).

For example, when the first crease processing section 210 and the second crease processing section 220 are to form a valley fold and a mountain fold on the sheet at the same time, the respective cam portions 242 and 252 are fixed to the transmission shaft portion 230 via the clutches 234 and 236 at the positions illustrated in FIGS. 5A and 6A.

The first drive section 240 and the second drive section 250 are configured to form a crease in each of the first crease processing section 210 and the second crease processing section 220 by the cam mechanisms including the cam portions 242 and 252 and the link mechanisms, respectively. However, the configuration is not limited thereto.

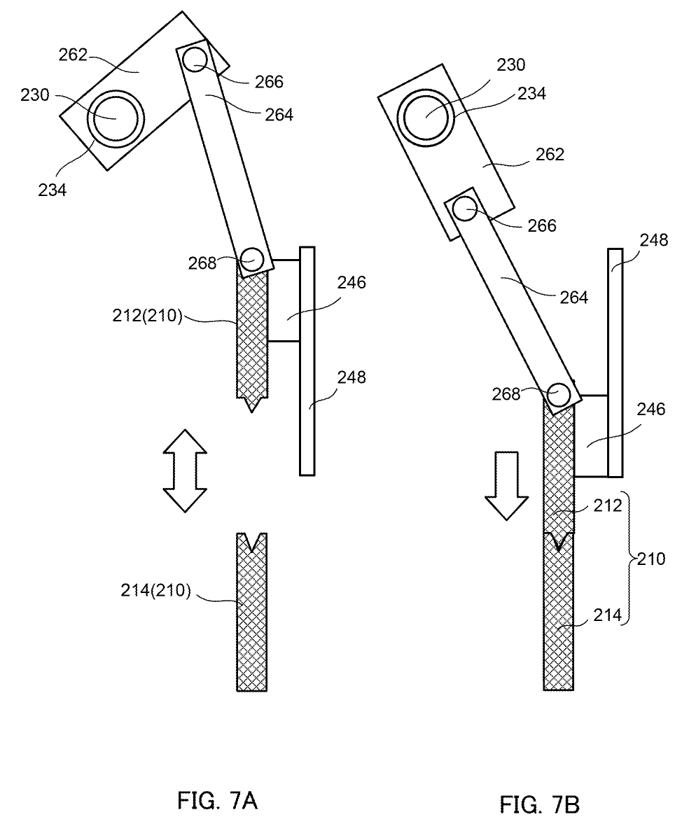

For example, as shown in a drive section (first and second link mechanism sections) 260 of FIG. 7, the drive section may be configured by a slider and crank mechanism including two arm portions (262 and 264) instead of cam portions 242 and 252 and link portions 244 and 254, a sliding portion 260, and a guide portion 248.

The drive section 260 is connected to the transmission shaft portion 230 at a position not overlapping in the axial direction, corresponding to each of the first crease processing section 210 and the second crease processing section 220.

As shown in FIG. 7A, the drive section 260 includes, for example, a first arm portion 262, a second arm portion 264, a sliding portion 246, and a guide portion 248.

One end portion of the first arm portion 262 is fixed to the transmission shaft portion 230 via a clutch 234, and one end portion of the second arm portion 264 is rotatably attached to the other end portion of the first arm portion 262 via a shaft portion 266.

The first arm portion 262 and the second arm portion 264 are connected to each other so as to be in a bent state when the first protruding portion 212 is at a position facing and spaced apart from the first recessed portion 214.

The respective constituent members constituting the link mechanism are connected to each other so that the second arm portion 264 extends downward by the rotation of the first arm portion 262 to displace the first protruding portion 212 downward.

The other end portion of the second arm portion 264 is rotatably attached to one of the first protruding portion 212 and the first recessed portion 214 and one of the second recessed portion 222 and the second protruding portion 224 (in FIG. 7, the first protruding portion 212) via the shaft portion 268.

The first protruding portion 212 is attached to the guide portion 248 via a sliding portion 246 so as to be movable in a reciprocating direction (a direction perpendicular to the conveyance surface).

By using the first arm portion 262 and the second arm portion 264, the rotation of the transmission shaft portion 230 can be converted into the movement of the first protruding portion 212 or the first recessed portion 214, and the rotation of the transmission shaft portion 230 can be converted into the movement of the second recessed portion 222 or the second protruding portion 224.

By mounting different types of processing modules including the crease module 200 in the post-processing device 2, various processed materials can be output correspondingly to products.

FIG. 8 is a diagram illustrating a post-processing device. FIG. 8A is a diagram schematically illustrating an example of a combination of modules in a post-processing device, and FIG. 8B is a diagram illustrating an example of a processed material output by the post-processing device illustrated in FIG. 8A.

The post-processing device 2 shown in FIG. 8A has three slots 20-1, 20-2 and 20-3.

The slots 20-1, 20-2, and 20-3 receive processing units such as the crease forming module 200, the FD cutting module 202, and the CD cutting module 203. The post-processing device 2 has the functions of the processing modules (200, 202, and 203) to be received.

The post-processing device 2 forms a mountain fold and a valley fold on the conveyed sheet S in the crease forming module 200, cuts the sheet S into two along the conveyance direction in the FD cutting module 202, and cuts the sheet S in the width direction by the CD cutting module 203.

Thus, it is possible to produce two processed materials SH used as elongated pamphlets having mountain-fold portions and valley-fold portions as illustrated in FIG. 8B.

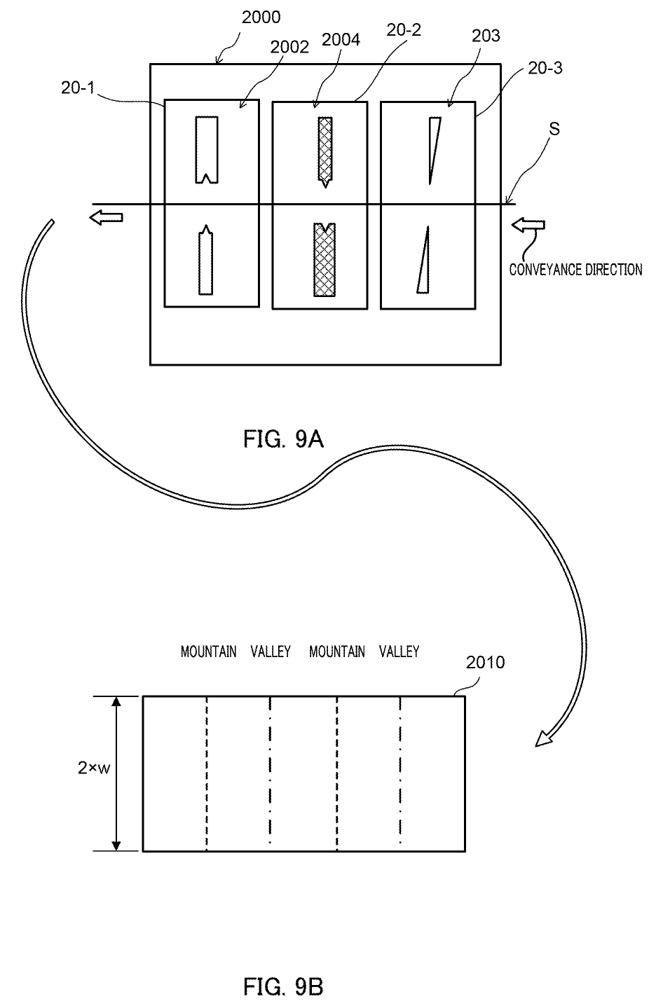

On the other hand, in a post-processing device 2000 having a crease processing portion as a reference shown in FIG. 9, a mountain fold processing module 2002, a valley fold processing module 2004, and a CD cutting module 203 are mounted in three slots 20-1, 20-2, and 20-3, respectively. Therefore, the FD cutting module 202 (see FIG. 8) cannot be mounted. As a result, in the post-processing device 2000 as the reference, the processed material 2010 having the mountain fold and the valley fold with a large width shown in FIG. 9B is manufactured, and an elongated pamphlet cannot be created, and the flexibility of the processing of the sheet is reduced. As described above, according to the image forming apparatus 100 of the present embodiment, it is possible to arrange the apparatus in a limited space without increasing the size of the apparatus itself, and to perform various processing on the sheet.

That is, according to the image forming apparatus 100, it is possible to reduce the size and increase the degree of freedom of processing including crease processing on a sheet.

### Embodiment 2

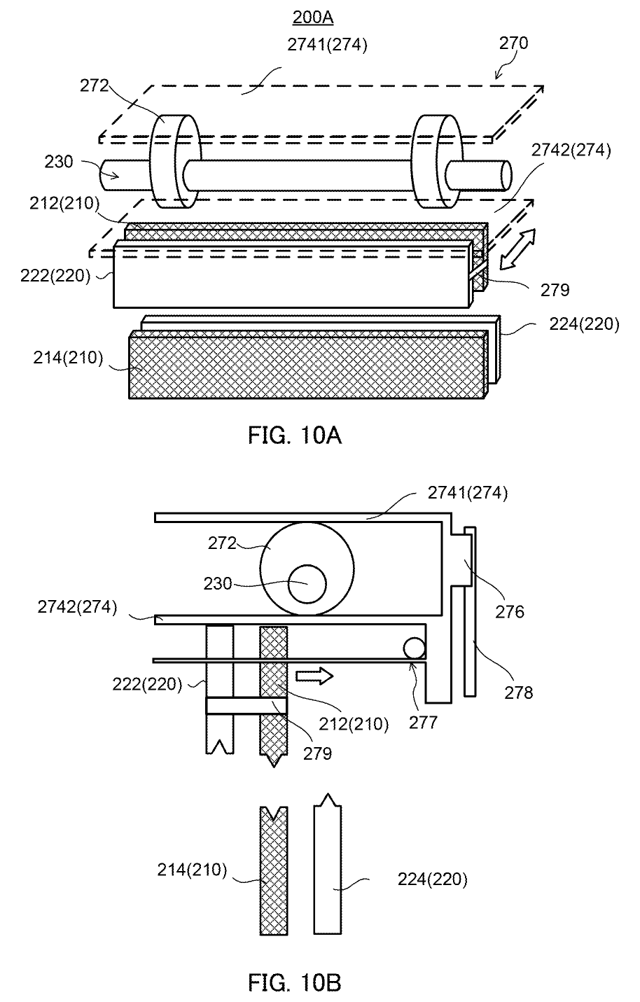

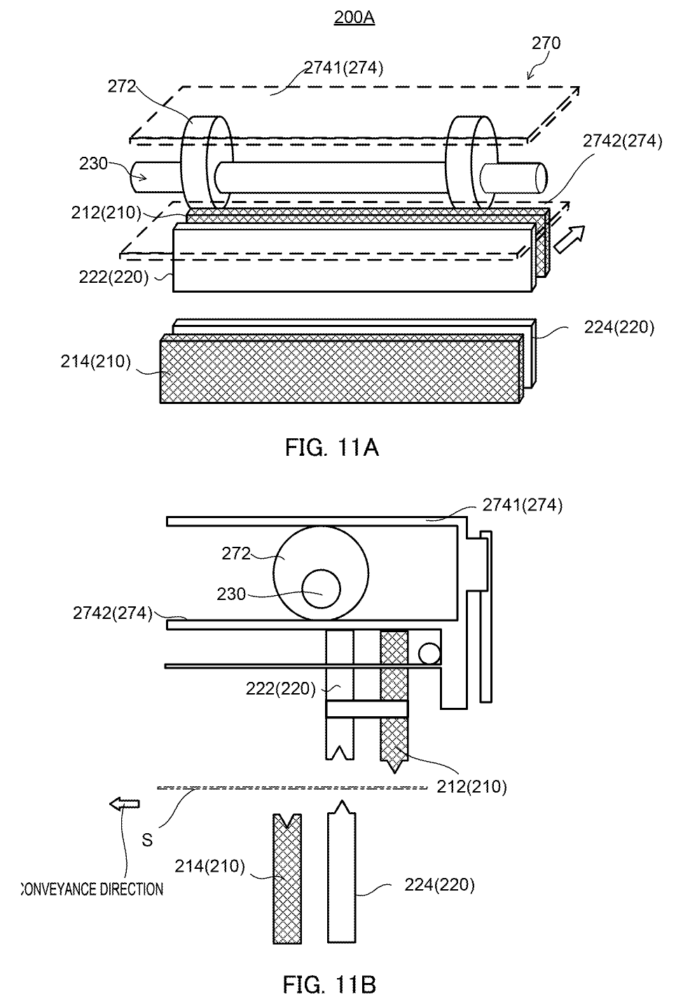

FIG. 10A is a schematic diagram of a crease module showing a configuration of a main part of a post-processing device according to Embodiment 2 of the present invention, and FIG. 10B is a diagram schematically showing a positional relationship of a crease processing section in FIG. 10A. Furthermore, FIG. 11A is a schematic diagram of the crease module after the first crease processing section is moved in FIGS. 10A and 11B is a schematic diagram illustrating a positional relationship of the crease processing sections in FIG. 11A.

As in the crease module 200A of the post-processing device 2 according to Embodiment 2, the driving force by the driving source of the post-processing device 2 may be simultaneously transmitted to both the first protruding portion 212 of the first crease processing section 210 and the second recessed portion 222 of the second crease processing section 220, which are capable of reciprocating. Alternatively, when the first recessed portion 214 and the second protruding portion 224 are moved, the crease module 200A may simultaneously transmit the driving force to both of them.

In this case, when the first protruding portion 212 and the first recessed portion 214 of the first crease processing section 210 are engaged (meshed) with each other, the second recessed portion 222 and the second protruding portion 224 of the second crease processing section 220 are not engaged (not meshed) with each other. When the second recessed portion 222 and the second protruding portion 224 of the second crease processing section 220 are engaged with each other, the first protruding portion 212 and the first recessed portion 214 of the first crease processing section 210 are arranged so as not to be engaged with each other. In the present embodiment, the cam mechanism is used as a transmission means of the driving force from the driving source (for example, the transmission shaft portion 230) to the first crease processing section 210 and the second crease processing section 220. Furthermore, the protruding portion or recessed portion that reciprocates in the direction perpendicular to the conveyance surface of the sheet S also reciprocate in the conveyance direction.

That is, in the crease module 200A, when a set of the protruding portion and the recessed portion of one of the first crease processing section 210 and the second crease processing section 220 are engaged with each other, a set of the protruding portion and the recessed portion of the other are arranged so as not to be engaged with each other.

The crease module 200A illustrated in FIG. 10A is mounted in the slot 20 (refer to FIGS. 1 to 3) and drives the first crease processing section 210 and the second crease processing section 220 to form one or both of a mountain fold and a valley fold on the sheet to be conveyed.

The crease module 200A includes the first crease processing section 210, the second crease processing section 220, the transmission shaft portion 230, and the same drive section 270.

The first crease processing section 210 and the second crease processing section 220 are arranged in a state where the positions of the first recessed portion 214 and the second protruding portion 224 are reversed compared to Embodiment 1, and have a structure in which the first protruding portion 212 and the second recessed portion 222 are moved relative to the first recessed portion 214 and the second protruding portion 224 to be engaged with each other.

In the crease module 200A, for example, the first protruding portion 212 of the first crease processing section 210 and the second recessed portion 222 of the second crease processing section 220 are arranged above in the vertical direction with respect to the conveyance surface of the sheet in such a manner as to be spaced apart from each other in the order from the upstream side in the conveyance direction.

The first protruding portion 212 and the second recessed portion 222 are configured to be integrally movable in the conveyance direction. The first protruding portion 212 and the second recessed portion 222 are, for example, integrally provided via a coupling portion 279, and are movably attached to a lower portion of the link portion 274 in the conveyance direction.

The second protruding portion 224 of the second crease processing section 220 and the first recessed portion 214 of the first crease processing section 210 are arranged below in the vertical direction with respect to the conveyance surface in such a manner as to be spaced apart from each other in the order from the upstream side in the conveyance direction.

When the crease module 200A is received in the slot 20 (refer to FIGS. 1 to 3), the transmission shaft portion 230 is connected to the drive source of the module drive section 28 via the drive connection portion 282. In the transmission shaft portion 230, the cam portion 272 is disposed to be separated from the first crease processing section 210 and the second crease processing section 220 in a direction perpendicular to the conveyance surface.

The transmission shaft portion 230 is, for example, disposed above a space between the first crease processing section 210 and the second crease processing section 220 with respect to the first crease processing section 210 and the second crease processing section 220.

The crease module 200A is configured to form creases (a valley fold and a mountain fold) by the first crease processing section 210 or the second crease processing section 220 through the same drive section 270 by the rotation of the transmission shaft portion 230.

The same drive section 270 has the cam portions 272 eccentrically attached to the transmission shaft portion 230, the link portion 274 vertically displaced by the rotation of the cam portion 272, and the guide portion 278 for guiding the vertical movement of the link portion 274.

The cam portions 272 are similarly fixed to the transmission shaft portion 230 with a predetermined distance in between, and their upper end positions and lower end positions are displaced by the rotation of the transmission shaft portion 230.

The link portion 274 includes upper and lower portions 2741 and 2742 which sandwich the cam portions 272 in the vertical direction (reciprocating direction), and the first protruding portion 212 and the second recessed portion 222 are movably disposed on the lower portion 2741.

In the link portion 274, the upper and lower portions 2741 and 2742 are coupled together and are disposed so as to be movable in an up-down direction (a direction perpendicular to the conveyance surface), which is a reciprocation direction, along the guide portion 248 via the slide portion 246.

The link portion 274 is pressed by displacement of the upper end positions and the lower end positions of the cam portions 272 due to rotation of the cam portions 272 between the upper and lower portions 2741 and 2742, and is displaced up and down.

As a result, the first protruding portion 212 and the second recessed portion 222 of the lower portion 2742 can move in the downward direction and engage (mesh) with the first recessed portion 214 and the second protruding portion 224, respectively.

A moving body including the first protruding portion 212 and the second recessed portion 222 is provided on the lower portion 2742 of the link portion 274 so as to be movable in the conveyance direction via a movement mechanism section 277. The movement mechanism section 277 includes, for example, a motor and a long worm gear, and rotates the worm gear that meshes with a gear of the moving body to move the moving body.

For example, in the state of the crease module shown in FIGS. 10A and 10B, the movement mechanism section 277 positions the first protruding portion 212 at a position facing the first recessed portion 214. At this time, nothing is disposed at a position facing the second recessed portion 222 in the downward direction. Accordingly, by the rotation of the transmission shaft portion 230, the entire link portion 274 is moved downward, and only the first protruding portion 212 is pressed against and engaged with the first recessed portion 214 without engagement of the second recessed portion 222.

When the crease is formed by the second crease processing section 220, as shown in FIGS. 11A and 11B, the second recessed portion 222 is positioned at an opposing position directly above the second protruding portion 224 by sliding the moving body to the rear side via the movement mechanism section 277.

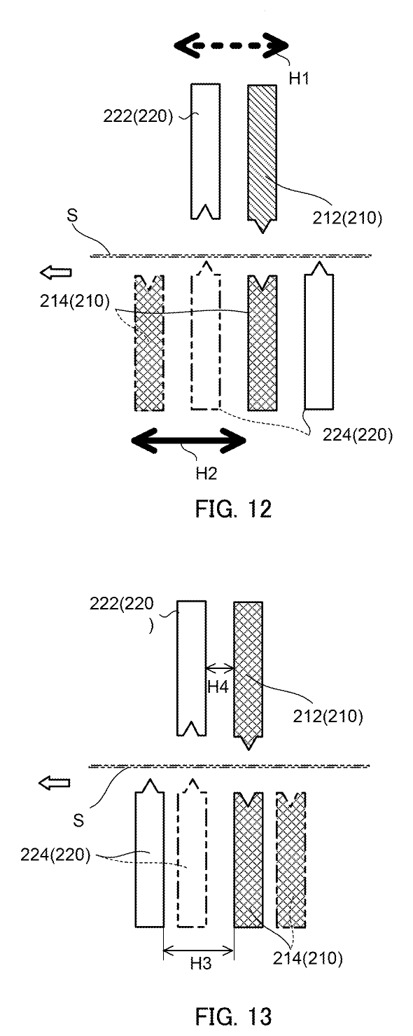

FIG. 12 is a schematic diagram showing a modification example of the arrangement of the first crease processing section and the second crease processing section in the crease module, which shows the main configuration of the post-processing device according to Embodiment 2 of the present invention.

In the crease module 200A, as illustrated in FIG. 12, the first protruding portion 212 of the first crease processing section 210 and the second recessed portion 222 of the second crease processing section 220 are configured to be reciprocally movable (arrow H1) in the conveyance direction with respect to the fixed first recessed portion 214 and second protruding portion 224.

In the crease module, as long as the crease is formed by engaging the first protruding portion 212 and the first recessed portion 214 with each other and engaging the second recessed portion 222 and the second protruding portion 224 with each other, the arrangement and the configuration of each portion are not limited.

For example, as shown in FIG. 12, the first recessed portion 214 and the second protruding portion 224 on the lower side with respect to the conveyance surface of the sheet S may be moved in the conveyance direction indicated by the arrow H2. In this case, the first protruding portion 212 and the second recessed portion 222 on the upper side may be configured to be movable only in the vertical direction, that is, the direction perpendicular to the conveyance surface.

Of the second protruding portion 224 and the first recessed portion 214, the first recessed portion 214 as a receiving base for the first protruding portion 212 at a position shown by a solid line engages with the first protruding portion 212 pressed. Further, the second protruding portion 224 and the first recessed portion 214 are located at positions indicated by broken lines, there is no processed portion opposed to the first recessed portion 214, and the second protruding portion 224 is located at a position opposed to the second recessed portion 222 and engages with the second recessed portion 222 as a receiving base. The first recessed portion 214 and the second protruding portion 224 are integrally provided and are moved in the conveyance direction indicated by the arrow H2 by the movement mechanism section 277.

(Arrangement Example of First Protruding Portion 212, First Recessed Portion 214, Second Recessed Portion 222, and Second Protruding Portion 224)

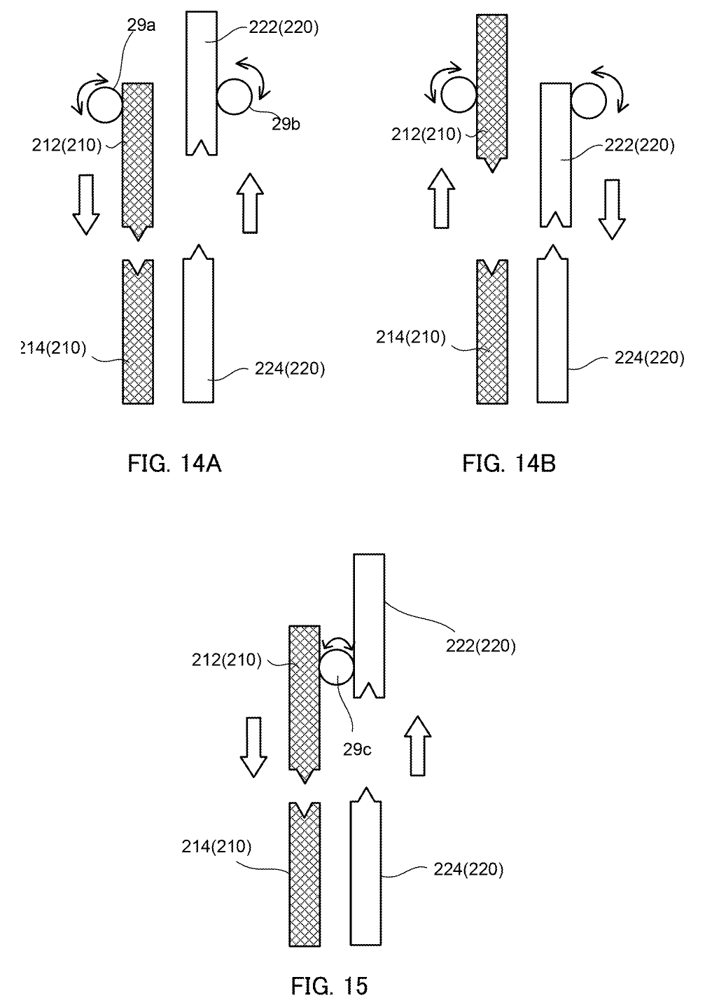

FIG. 13 is a diagram illustrating a modification example of the arrangement of the first crease processing section and the second crease processing section. Further, FIGS. 14A and 14B are views showing another modification example of the arrangement of the first crease processing section and the second crease processing section, and FIG. 15 is a view showing another modification example of the arrangement of the first crease processing section and the second crease processing section.

As shown in FIG. 13, the first protruding portion 212 and the second recessed portion 222 may be arranged in the presented order from the upstream side in the conveyance direction above the conveyance surface, and the first recessed portion 214 and the second protruding portion 224 may be arranged in the presented order from the upstream side in the conveyance direction below the conveyance surface.

In this case, the interval H3 between the first recessed portion 214 and the second protruding portion 224 in the conveyance direction is wider than the interval H4 between the first protruding portion 212 and the second recessed portion 222. This interval is provided so that the first protruding portion 212 descending together with the second recessed portion 222 does not interfere with the first recessed portion 214.

In the first crease processing section 210 and the second crease processing section 220 illustrated in FIG. 13, the arrangement order of the first protruding portions 212 and the second recessed portions 222 in the conveyance direction is opposite to the arrangement order of the first recessed portions 214 and the second protruding portions 224 in the conveyance direction, compared to the arrangement order illustrated in FIGS. 10 to 12.

That is, the arrangement order of the first protruding portion 212 of the first crease processing section 210 and the second recessed portion 222 of the second crease processing section 220 in the conveyance direction is the same as the arrangement order of the first recessed portion 214 of the first crease processing section 210 and the second protruding portion 224 of the second crease processing section 220 in the conveyance direction.

In this modification example, a mechanism section for engaging and disengaging the recessed portion and the protruding portion of each of the crease processing sections 210 and 220 may be provided on the lower side of the conveyance surface on which the sheet is conveyed.

In any of the configurations, one set of the first protruding portion 212 and the second recessed portion 222 and the first recessed portion 214 and the second protruding portion 224 on the upper and lower sides of the sheet 2 is provided to be movable with respect to the other set to a position where the corresponding recessed and protruding portions are engaged with each other.

Furthermore, in the first crease processing section 210 and the second crease processing section 220 illustrated in FIG. 14, the first recessed portion 214 and the second protruding portion 224 are arranged below the conveyance surface (the surface on which the sheet S is arranged) to vertically face the conveyance surface. In addition, the first protruding portion 212 and the second recessed portion 222 are disposed above the conveyance surface to face the conveyance surface vertically . The crease module having this configuration includes, for example, a drive section (not illustrated) that drives the first crease processing section 210 and the second crease processing section 220. The drive section moves at least one of the first protruding portion 212 and the first recessed portion 214 and moves at least one of the second recessed portion 222 and the second protruding portion 224.

In this way, the drive section drives both the first crease processing section and the second crease processing section to alternately engage the first protruding portion and the first recessed portion with each other and the second recessed portion and the second protruding portion with each other.

Each of the first protruding portion 212 and the second recessed portion 222 which move is provided so as to be movable downward (toward the first recessed portion 214 or the second protruding portion 224) via the drive sections 29a and 29b. In this way, the protruding portion or the recessed portion of one of the first crease processing section 210 and the second crease processing section 220 which is used is made to protrude, and the other that is not used is made to retract. In this state, the protruding portion or the recessed portion to be used is protruded, and the protruding portion or the recessed portion not to be used is retracted. In FIG. 14A, the first protruding portion 212 is protruded toward the first recessed portion 214 on the receiving side, and the second recessed portion 222 is retreated from the second protruding portion 224 side. In this state, the first protruding portion 212 and the second recessed portion 222 on the pressing side (here, the upper moving body) are pressed against the lower portion (the first recessed portion 214 and the second protruding portion 224). Accordingly, the crease can be processed (creasing can be performed) only by the protruding portion or the recessed portion which is the protruding crease processing portion.

The drive sections 29a and 29b may have any structure as long as the drive sections 29a and 29b reciprocate the first protruding portion 212 and the second recessed portion 222, respectively, in a direction perpendicular to the conveyance surface (up-down direction), and may have a well-known structure. The drive sections 29a and 29b may be formed by a rack-and-pinion mechanism or a slider-and-crank mechanism.

The first protruding portion 212 and the second recessed portion 222 are disposed so as to be vertically movable via a slider or the like that slides on a rail, and a rack portion is provided on a side surface of each of the first protruding portion 212 and the second recessed portion 222, and a pinion of a motor fixed to the rack portion is meshed with the rack portion.

According to this configuration, the structure can be simplified, and since the positional relationship of the crease processing section in the sheet conveyance direction is fixed, the recessed portion and the protruding portion can be engaged with each other with high accuracy, and the quality of the crease can be secured. In addition, it is possible to reduce the size of the apparatus and increase the flexibility of processing including crease processing with respect to the sheet.

In addition, a mechanism capable of independently reciprocating the first protruding portion 212 of the first crease processing section 210 and the second recessed portion 222 of the second crease processing section 220 in a direction perpendicular to the conveyance surface of the sheet S is provided.

Furthermore, the first protruding portion 212 and the second recessed portion 222 illustrated in FIG. 12, which are arranged opposite the first recessed portion 214 and the second protruding portion 224 with the conveyance plane in between, may be driven by a single drive section.

FIG. 15 illustrates the drive section 29c between the first protruding portion 212 and the second recessed portion 222, the drive section being configured to move each of the first protruding portion 212 and the second recessed portion 222 so as to alternately protrude downward.

The drive section 29c transmits a driving force from the drive source to both of the protruding portions or recessed portions, which are capable of reciprocating, in the first crease processing section 210 and the second crease processing section 220 at the same time.

The drive section 29c is, for example, configured to be connected to the drive connection portion 282 and driven when attached to the slot, and is driven to move the first protruding portion 212 and the second recessed portion 222. The drive section 29c may include, for example, a pinion gear that rotates by driving (e.g., rotation) of the drive connection portion 282. The pinion gear is connected to each of the racks of the first protruding portion 212 and the second recessed portion 222 in the conveyance direction and is configured such that when the pinion gear rotates in one direction, one of the racks moves upward and the other moves downward. Note that the crease module itself may be provided with a drive source for driving the drive section 29c.

In addition, in the above-described embodiment, the driving member is the motor itself, but the invention is not limited thereto, and the driving member may be a driving mechanism to which a driving force is transmitted from a driving source such as a motor provided in an external device.

In addition, each of the above-described embodiments is merely an example for embodying the present invention, and the technical scope of the present invention should not be interpreted in a limited manner by these embodiments. That is, the present invention can be implemented in various forms without departing from the spirit or main features thereof.

Although embodiments of the present invention have been described and illustrated in detail, the disclosed embodiments are made for purpose of illustration and example only and not limitation. The scope of the present invention should be interpreted by terms of the appended claims.

What is claimed is:

1. A post-processing device, comprising:
a crease forming module that forms a crease in a sheet; and
a slot section that receives the crease forming module, wherein
the crease forming module includes:
a first crease processor that includes a first protruding portion facing a first surface of the sheet and a first recessed portion facing a second surface of the sheet, and forms a first crease in the sheet by engagement between the first protruding portion and the first recessed portion, and
a second crease processor that includes a second recessed portion facing the first surface of the sheet and a second protruding portion facing the second surface of the sheet and forms a second crease in the sheet by engagement between the second recessed portion and the second protruding portion.

2. The post-processing device according to claim 1, wherein
the first protruding portion and the first recessed portion, and the second recessed portion and the second protruding portion are provided to extend in a direction orthogonal to a conveyance direction of the sheet, and each pair forms a folding line extending in the orthogonal direction.

3. The post-processing device according to claim 1, wherein
the first crease processor and the second crease processor are provided side by side in the same direction as the conveyance direction of the sheet.

4. The post-processing device according to claim 1, wherein:
at least one of the first protruding portion and the first recessed portion moves in a direction perpendicular to the sheet such that the sheet is sandwiched between the first protruding portion and the first recessed portion, and is engageable with and disengageable from the other of the first protruding portion and the first recessed portion, and
at least one of the second recessed portion and the second protruding portion moves in the direction perpendicular to the sheet such that the sheet is sandwiched between the second recessed portion and the second protruding portion and is engageable with and disengageable from the other of the second recessed portion and the second protruding portion.

5. The post-processing device according to claim 4, wherein:
the crease forming module includes a driver that drives the first crease processor to move at least one of the first protruding portion and the first recessed portion, and drives the second crease processor to move at least one of the second recessed portion and the second protruding portion, and
the driver selectively drives the first crease processor and the second crease processor.

6. The post-processing device according to claim 5, wherein
the driver includes:
a transmission shaft portion that is connected to a drive source when the crease forming module is received in the slot section,
a first link mechanism section that connects the transmission shaft portion to the first protruding portion or the first recessed portion and converts rotation of the transmission shaft portion into movement of the first protruding portion or the first recessed portion, and
a second link mechanism section that connects the transmission shaft portion to the second recessed portion or the second protruding portion and converts the rotation of the transmission shaft portion into movement of the second recessed portion or the second protruding portion.

7. The post-processing device according to claim 6, wherein
the first and second link mechanism sections include at least one of a cam mechanism, a slider crank mechanism, or a rack and pinion mechanism.

8. The post-processing device according to claim 6, further comprising:
a first clutch configured to transmit or interrupt a driving force from the transmission shaft portion to the first link mechanism section; and
a second clutch configured to transmit or interrupt a driving force from the transmission shaft portion to the second link mechanism section.

9. The post-processing device according to claim 5, wherein
the crease forming module is configured to simultaneously drive the first crease processor and the second crease processor such that when one of a pair of the first protruding portion and the first recessed portion and a pair of the second recessed portion and the second protruding portion is engaged with each other, the other pair is not engaged.

10. The post-processing device according to claim 9, further comprising:
a mechanism section that integrally supports the first protruding portion and the second recessed portion and is provided so as to be capable of reciprocating in the conveyance direction of the sheet, wherein
the first protruding portion or the second recessed portion moves by the mechanism section to a position where the first protruding portion or the second recessed portion is engageable with the first recessed portion or the second protruding portion.

11. The post-processing device according to claim 10, wherein:
the first protruding portion of the first crease processor and the second recessed portion of the second crease processor are arranged from an upstream side in the conveyance direction in an order presented, and
the second protruding portion of the second crease processor and the first recessed portion of the first crease processor are arranged from the upstream side in the conveyance direction in an order presented.

12. The post-processing device according to claim 10, wherein:
the first protruding portion of the first crease processor and the second recessed portion of the second crease processor are arranged from an upstream side in the conveyance direction in an order presented,
the first recessed portion of the first crease processor and the second protruding portion of the second crease processor are arranged from the upstream side in the conveyance direction in an order presented,
an interval between the first recessed portion and the second protruding portion is longer than an interval between the first protruding portion and the second recessed portion, and
when the second protruding portion and the first protruding portion move and the second protruding portion engages with the second recessed portion, the first protruding portion is located between the first recessed portion and the second protruding portion.

13. The post-processing device according to claim 4, wherein:
the crease forming module includes a driver that drives the first crease processor to move at least one of the first protruding portion and the first recessed portion, and drives the second crease processor to move at least one of the second recessed portion and the second protruding portion, and
the driver drives both of the first crease processor and the second crease processor to alternately engage the first protruding portion with the first recessed portion and the second recessed portion with the second protruding portion.

14. An image forming apparatus, comprising:
an image forming apparatus main body that forms an image on the sheet; and
the post-processing device according to claim 1.
